(19) United States
(12) Patent Application Publication
(10) Pub. No.: US 2007/0198407 A1
(43) Pub. Date: Aug. 23, 2007

(54) Self-pay management system and process for the healthcare industry

(75) Inventor: Earl T. Winter, Nashville, TN (US)

Correspondence Address: EDWARDS ANGELL PALMER & DODGE LLP, P.O. BOX 55874, BOSTON, MA, 02205, US

(73) Assignee: nTelagent, Nashville, TN (US)

(21) Appl. No.: 11/701,691

(22) Filed: Feb. 1, 2007

Related U.S. Application Data
(60) Provisional application No. 60/764,585, filed on Feb. 2, 2006.

(51) Int. Cl. G06Q 40/00

(52) U.S. Cl. 705/40

(57) ABSTRACT

A system and method are described for quickly supplying health care and other service providers with a financial profile of those customers who must pay for all or a portion of their services out of pocket. This allows the service provider to make more consistent and effective decisions about managing collections from customers, thereby reducing bad debt expense. The system can alternatively help the service provider inform its customers about options for financial assistance. The method includes obtaining identifying data from the service provider, obtaining demographic and market data pertaining to the customer from third party sources, generating an independent financial profile of the customer, and timely providing the service provider with this information and a suggested payment plan.

### CROSS-REFERENCE TO RELATED APPLICATION

This application claims the benefit of priority to U.S. Provisional Patent Application No. 60/764,585 filed Feb. 2, 2006, which is incorporated herein by reference.

### BACKGROUND OF THE INVENTION

1. Field of the Invention

This invention relates to a system and method of assisting healthcare and other types of service providers to improve collections from patients or consumers who must pay for at least some of their services out-of-pocket (self-pay patients), and where appropriate, to advise those consumers in obtaining financial assistance. (As used herein, the terms “patient,” “customer” and “consumer” are used interchangeably). The invention can be particularly appropriate for health care service providers. It utilizes a process of gathering public market information through a plurality of databases to develop a financial profile of the consumer. In particular, the invention can utilize computer software, systems and methods to assist the healthcare service provider in making more rapid and effective decisions about collections, discounting procedures, and payment plan options, by using a telecommunications, internet or telephone link to a centralized computer database and decision-support system. In one embodiment, it can provide real-time verification of consumer or customer addresses and phone numbers, as well as additional financial data to assist the healthcare (or other) service provider in applying an optimized and standardized collection procedure to patient or consumer accounts at the initial registration for service, or at any time thereafter.

2. Background of the Relevant Art

Personnel employed by a healthcare provider currently perform manual verification of a consumer's address, phone number, and other information. Attempts to negotiate payment plans and discounts are performed in an ad-hoc and inefficient manner, and often without a complete set of information about the financial status of the consumer receiving services. This adds overhead expense and creates delays, thereby reducing potential revenues. Moreover, the current methods of analyzing the consumer's financial qualifications for Medicaid coverage or other forms of community financial assistance plans is slow, cumbersome and often incomplete.

A health care provider must often render services to customers without being able to collect full payment at the time of service. If the customer has insurance coverage, the provider will often only be able to collect payment at a significantly later date, often dictated by contractual agreement between the service provider and the insurer. If the customer has no insurance to cover all of the services rendered, (a “self-pay” customer) then the provider must obtain payment directly from the customer or from an individual responsible for payment (a “guarantor”). (As used herein, the terms guarantor, customer, consumer and patient can be used interchangeably when referring to a person financially responsible for payment for a service). Frequently, up-front payment will not be possible. The extent of services to be provided is not always known at the initiation of treatment. The service provider may be obligated to provide a certain amount of service (such as emergency services), regardless of the guarantor's insurance or ability to pay. There may be other regulatory, ethical, moral or public relations reasons for the provider to render services without first securing payment. In these circumstances, the provider must bill the guarantor for payment after the service has been rendered. Particularly with uninsured guarantors, the balance owed may be impossible to collect because the payment demanded exceeds the self-pay guarantor's discretionary cash flow. Negotiating with a patient or guarantor to enter into a payment plan after the service has been provided can be difficult and time-consuming, requiring unique customer-relations skills. It is generally too expensive for most providers to employ appropriately skilled representatives in sufficient numbers to routinely negotiate such payments after-the-fact.

It has been estimated that 10% of the expenses of for-profit hospitals go to bad debt and charity care. Up to 70% of self-pay charges are written off to bad debt, which translates to nearly $30 billion in health care charges nationwide. Approximately 45 million Americans do not have health insurance, and many more are underinsured. Over 8% of people earning more than $75,000 annually do not have health insurance. This is the fastest growing segment of the uninsured patient population. Thus a substantial number of self-pay patients presumably could afford to pay for their care, were they to be approached by service providers with a payment plan appropriate to their financial circumstances.

Having accurate information about the patient or his/her guarantor can be an important component of an effective self-pay management system. (As used herein, a “self-pay management system” can also be referred to as a “decision support provider”). With an independent assessment of the guarantor's financial condition, the service provider can have enough information to automate and standardize the application of an individualized payment plan. Equipped at the outset with a realistic payment plan, the provider's representative is more likely to reach an agreement with the guarantor. Moreover, the ability to begin these discussions with the guarantor at the beginning of the service further improves the likelihood of reaching an agreement on payment. Alternatively, the sooner the provider can determine that the guarantor does not have the financial resources to enter into an acceptable payment plan, the easier it will be for the provider's representative to direct him or her to possible sources of financial assistance.

### SUMMARY OF THE INVENTION

The present invention is directed to a system (a “self pay management system”) and method for estimating a patient or guarantor's ability to pay for a service, allowing the service provider to maximize reimbursement by structuring a payment plan acceptable to both the service provider and the patient or guarantor. It enables a broader group of service provider employees (including registrars, financial counselors, administrative staff, business office personnel, as well as collections personnel) to be involved in establishing individualized payment arrangements with patients. These arrangements can be based on standardized policies, and can incorporate reasonable terms, flexible payment options, proper identification and verification of insurance coverage, deductibles and co-payments, and screening for Medicaid or charity care qualification in a consistent manner throughout the organization. The service provider can be any entity that provides a service for which full payment is not provided at the time of service delivery.

In one embodiment, the service provider is a health care service provider, and at least part of the service is not reimbursed by insurance. The method comprises having a representative of the service provider submit identification information about a guarantor who is responsible for paying for the service (either the patient receiving the service or another party who is financially responsible for payment). Historical information about the patient or guarantor obtained from outstanding or prior accounts can also be submitted and incorporated with the identification information. As a result of submitting this information, the service provider can then receive further information regarding the guarantor, including a verification of the guarantor's identification information, a financial profile of the guarantor, and an estimate of the guarantor's ability to pay for the service in question. The service provider can choose to receive any or all of these items of information. The service provider can then present a payment plan to the guarantor based on the information received. The identification information submitted by the service provider can include any combination of the guarantor's name, address or telephone number. The information about the guarantor's financial profile obtained by the service provider can include demographic and market information about the guarantor. As used herein, this demographic and market information can include information about the guarantor's residence, including but not limited to the residence location, the residence duration, the residence occupancy profile and the residence economic profile. The demographic and market information can also include information about the spending patterns of the guarantor, including the names and types of the guarantor's credit card providers, the frequency and type of credit card purchases made by the guarantor, and the value of purchases made with credit cards.

After receiving the financial profile information, the service provider can calculate an estimate of the guarantor's ability to pay for the service. Using the information received, the service provider can also generate a payment plan to present to the guarantor. Such a payment plan can include, for example, an agreed discount for the cost of the service, or a series of partial payments to be made over an agreed period of time. Formulation of a payment plan can be based on variables including the estimated cost of the service, the guarantor's financial profile, the guarantor's estimated ability to pay, the amount of payment made at the actual time of service, the discount the service provider is willing to offer, the number of partial payments and the duration of a payment period agreeable to the service provider and the guarantor, and the size of each partial payment.

The service provider can categorize the ranges of values associated with the variables comprising the guarantor's financial profile. The service provider can also categorize the ranges of values and limits associated with the variables comprising the available payment plans. Doing so allows a representative for the service provider to enter the values corresponding to an individual guarantor's financial profile into a computer in which payment plan variables and rules have been stored. The computer can then be programmed to calculate an estimate of the guarantor's ability to pay, and generate one or more payment plans based on that estimate. The computer system can form the hub of a self-pay management system, and can be located remotely. The service provider representative can access the self-pay management system via modem wirelessly, or via a fiberoptic, coaxial or telephone cable network. By this or other means, the service provider is able to acquire verification and financial information regarding the guarantor or customer from databases managed by third parties.

The present invention is also directed to methods by which a self-pay management system receives identification information about a guarantor from a service provider. The self-pay management system can then submit this information to one or more third party databases for the purpose of verifying the identification information, or for the purpose of generating a financial profile of the guarantor, or both. The self-pay management system, after receiving this information, can generate a summary of the third-party information that includes the verification information and the financial profile information, which it can then send to the service provider. The identification information can include the guarantor's name, address and telephone number. The financial profile information can include demographic and market information about the guarantor. The demographic and market information can comprise information about the guarantor's residence, including residence location, residence duration, residence occupancy profile, residence economic profile, or a combination. The demographic and market information can additionally comprise information about at least one of the guarantor's credit card providers, and include information about the frequency, type and value of purchases made by the guarantor.

The self-pay management system can additionally calculate an estimate of the guarantor's ability to pay from the third-party financial information, using specific business rules developed in conjunction with the individual service provider. The financial profile can be generated from third party demographic and market data, as well as the service provider's knowledge about the patient or guarantor's prior payment history. Furthermore, the self-pay management system can optionally select one or more payment plans based on the demographic and market information received from the third-party databases.

The self-pay management system can calculate a payment plan by applying a discount to the estimated cost of the service, or by formulating a payment schedule over a period of time, or both. The payment plan generated can be a function of the value of the service provided, the guarantor's financial profile, the estimate of the guarantor's ability to pay, the amount of payment made at the time of service, the discount to be applied, the number of partial payments to be made, the duration of partial payments, or the amount of each partial payment, or any combination thereof.

In another embodiment, the invention is directed to a self-pay management system operated with a computer performing the appropriate calculations after the original identification information has been entered through an electronic terminal. The communications among the self-pay management system, the third party databases and the service provider can occur by modem communicating wirelessly, or via a fiberoptic, coaxial or telephone cable network system, or a combination thereof.

In one embodiment, the provider's representative can enter the identification information of the guarantor into a computer terminal, which can then transmit the information to a computerized self-pay management system. With this information, the self-pay management system can, for example, electronically query third party databases in order to verify the identification information and to obtain demographic and market data pertaining to the guarantor in order to develop a financial profile of the guarantor. The self-pay management system can perform the data communication, data collection and data processing operations required to provide financial information about a guarantor sufficient to allow a service provider to present a payment plan to a guarantor. The system can receive and store identification information about the guarantor. It can query one or more third party databases using the identification information to verify the accuracy of the information, or to obtain additional information sufficient to generate a financial profile of the guarantor, or both. It can receive this information, and then generate a summary regarding the guarantor that can include verification information, the financial profile, an estimate of the guarantor's ability to pay, and one or more payment plans designed according to the financial profile of the guarantor. The system can then communicate the summary, or any component thereof, to the service provider for presentation to the guarantor. The communication system can be one or more modems. The information can be transmitted among the self-pay management system, the third party databases, and the service provider wirelessly, or via fiberoptic, coaxial or telephone cable, or a combination thereof. The information received by the self-pay management system, and the rules for calculating a financial profile or a payment plan can be stored in a computer memory, and the summary data, reports and verification of identification information can be generated by a computer processor or server.

An object of the present invention is to improve a provider's ability to collect payment for services rendered by assembling reliable information about the customer or his/her financial guarantor. The information or decision support system (a “self-pay management system”), can be remotely located, and is able to electronically receive customer or guarantor identification data from the service provider, as well as additional information about the patient/customer or guarantor from third party data providers and other sources. The collected data (an expanded information profile, or a “financial profile”) can then be re-transmitted to the provider (registrar, financial counselor or other healthcare provider personnel) who entered the patient or guarantor identification data. The healthcare provider can then use this information to apply established protocols and procedures either to direct the consumer to a Medicaid Intake Director or other Medicaid eligibility coordinator, arrange for discounts or an extended payment plan based on income level or other criteria, or direct the patient to a financial counselor to otherwise arrange for payment.

In one embodiment, the expanded information profile is developed through electronic access to third party sources, providing such additional information as: name, address and telephone verification, education and occupation of adults in household, household or family income, number of adults and children in the household, estimated real estate values in the guarantor's neighborhood, and other demographic information. This information can be retrieved, organized and supplied to the healthcare provider within seconds of the consumer registration process. Some of the demographic information can include information about the guarantor's residence. For example, information about the residence location can be obtained, which can include information about the street, neighborhood, city, county, and region in which the guarantor resides. In turn each of these items of information can yield information about the median and average income and wealth level of other persons residing at similar locations. The service provider can also receive information about the residence duration, which can include information about how long the guarantor has lived at the current residence, the types and locations of other recent residences, the frequency with which the guarantor has moved, and whether the customer or guarantor has owned or rented the current or other recent residences. The service provider can also receive information about the residence occupancy profile, which can include the names, ages and occupations of the adults who live at the guarantor's address. The service provider can also receive information about the residence economic profile, which can include the estimated income, assets, liabilities and net worth of one or more adults living at the guarantor's residence.

The guarantor's financial profile can additionally consist of information from third party sources about the guarantor's spending patterns through his or her credit card-based purchasing activity. Information about the guarantor's credit card providers, the frequency and type of purchases, and the value of the purchases, can be acquired. This information can help the service provider or the self-pay management system to develop a profile of the guarantor's discretionary spending.

The self-pay management system can collect, organize and quickly communicate this information to the service provider's representative for further analysis or action. Preferably, this information is made available to the service provider representative in ‘real time’ (at the time the service is initiated). Optionally, the self-pay management system can also calculate in ‘real time’ an estimate of the guarantor's ability to pay, based on criteria pre-established by the service provider. Furthermore, the self-pay management system can generate in ‘real time’ one or more payment plans for presentation to the guarantor by the provider's representative. The range of payment plan options can be pre-established by the service provider, together with standardized criteria for choosing the most appropriate options. The invention can comprise a business logic processing unit that operates on client-specific data and is designed to provide rapid feedback to the registrar, financial counselor or other healthcare provider personnel with recommended actions regarding the discount level, percentage to collect at the time of service, and a payment schedule for the service. These decisions are supported by rules pre-determined by the individual health service provider and applied to the individual consumer based on consumer payment history, and financial and demographic information. Payment plan options can include (but are not limited to) discounts in return for early payment of charges or for automatic debiting of credit accounts, and periodic payments of a range of amounts over a range of time periods.

If the financial profile of the guarantor suggests that no reasonable payment plan is possible, the healthcare provider representative can optionally direct the guarantor to a financial counselor for assistance in applying for financial aid. The system can, for example, quickly identify those patients suitable for charity care, the financial criteria having been pre-determined by the health care provider. Optionally, the self-pay management system can generate a list of financial aid options available to the guarantor, based on his or her financial profile.

In another embodiment, the invention can additionally comprise a ‘virtual counseling service’ available to the patient or guarantor at any time starting from the initiation of registration for healthcare services. This counseling service can include (but is not limited to): explanations of the provider's financial policy, available payment options, suggested payment programs based on the consumer's expanded data profile, assistance in Medicaid qualification, and eligibility for community financial assistance programs.

In a further embodiment, the self-pay management system can provide an entity with a financial profile of a customer whom the entity has already billed or plans to bill. Providing an estimate of a customer's ability to pay can help the billing entity to prioritize its collection efforts on outstanding accounts. This can be particularly advantageous to collection agencies, practitioners' offices, and other goods and services providers.

One advantage of the invention is that payment arrangements or other plans for reimbursement can be initiated within seconds or minutes of the time that the consumer registers with the healthcare provider for service. Reports can be delivered in any of a number of modes, including email, internet, and via the telephone.

Another advantage of the invention is that some of the consumer's/guarantor's demographic information can be verified at the time of registration, saving the health services provider from having to expend valuable resources later verifying and correcting the information.

Another advantage of the invention is that counseling and referrals regarding Medicaid qualification, referrals for financial counseling, and referrals to community financial assistance programs can be initiated on a 24 hour per day, 7 day per week basis.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE DRAWINGS

FIG. 1 is an overview of the self-pay management system, and its communications network with service providers and third party data providers.

FIG. 2 is a flow chart summarizing the interactions among the service provider, the self-pay management system, and third party data providers.

FIG. 3 is a flow chart showing representative functions of an administrator for the self-pay management system, compared with the functions of an administrator for the service provider.

FIG. 4 is a schematic demonstrating the hierarchical access available to various users of the self-pay management system, depending on their level of authority and the nature of their work.

FIG. 5A is a flow chart showing how accounting and finance systems can interact during a patient's progress through a hospital visit, and the points at which charges can be accumulated and payments arranged.

FIG. 5B is a flow chart showing a more simplified accounting and finance system that can be adapted to an outpatient facility or clinic.

FIG. 5C is a flow chart showing how patients with or without insurance can be approached either for payment of co-pays and deductibles, or for development of a payment plan

FIG. 5D is a flow chart showing how the self-pay management system can group patients or guarantors according to ability to pay so that individualized accounts receivable programs can be applied, how it can screen for Medicaid or charity care eligibility, and how it can verify the identity and market/demographic information pertaining to a patient or guarantor.

FIG. 6 is an example of a login page that a user must clear in order to access the self-pay management system.

FIGS. 7a and 7b are examples of data entry screens identifying the user of the system.

FIGS. 8a and 8b are examples of data entry screens identifying the recipient (or guarantor) of the service provider's services.

FIGS. 9, 10 and 11 show examples of possible verification responses by the self-pay management system to the user's entry of service recipient or guarantor identification information.

FIGS. 12 and 13 are examples of demographic and financial data returned by the self-pay management system in response to a user's entry of a recipient's or guarantor's identification information.

FIGS. 14, 15 and 16 are examples of how a user can interact with the self-pay management system when entering payment data related to a visit or a service.

FIG. 17 shows how a self-pay management system can monitor the level of authority that a user can exercise, based on the value of the service rendered.

FIGS. 18, 19 and 20 show how a self-pay management system can provide the user with a recommended payment plan, based on information it has obtained regarding the service recipient or guarantor, and how the user can notify the system of an individual's acceptance or rejection of the terms of payment.

FIGS. 21-23 show various financial reports on service recipients that the self-pay management system can be programmed to produce for the service provider.

FIG. 24 shows how the self-pay management can be programmed to generate financial projections of cash inflows, based on the payment plans currently administered by the service provider.

FIGS. 25 and 26 show administrator-selectable guarantor data to which a given user can be given access.

FIGS. 27 and 28 show the levels of security that an administrator for a service provider can select in granting a user or department access to various components of the self-pay management system.

FIG. 29 shows how scripted phraseology (‘scripts’) can be introduced to deal with issues such as charity care or collections, based on the role of the user accessing the system.

FIG. 30 shows how an administrator of a service provider can reset a user's clearance for accessing the self-pay management system.

FIG. 31 shows how an administrator of a service provider can edit the scripts to be provided to a patient/guarantor regarding issues such as a rejection of payment terms, and how it can be varied according to the user's department and role.

### DETAILED DESCRIPTION

The present invention overcomes many of the prior art problems associated with administering payment plans for services rendered to self-pay customers. The advantages, and other features of the systems and methods disclosed herein, will become more readily apparent to those having ordinary skill in the art from the following detailed description, in conjunction with the drawings, setting forth a representative embodiment of the present invention.

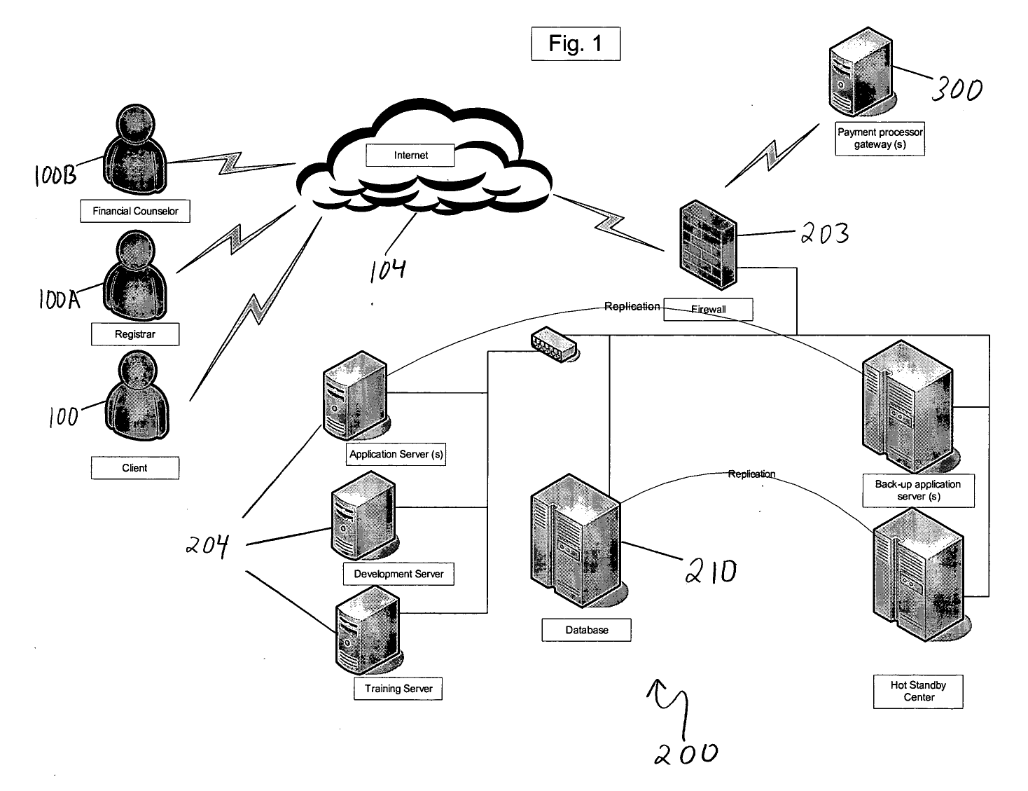

An overview of the self-pay management system is shown in FIG. 1. Service providers 100 (“Clients”) have access to the self-pay management system 200 via the internet 104. As representatives of a service provider, both Registrars 100A and financial counselors 100B have authorization to access the system 200. The system 200 can communicate bidirectionally with the service providers 100, and also has access to third party data providers 300. All communications are encrypted and pass through a firewall 203 to ensure data security. The self-pay management system 200 comprises one or more servers 204 to process the incoming and outgoing data, and one or more internal databases 210, which store the information gathered from the service providers 100 and the third party data providers 300. Back up servers at an off premise “Hot Site” that are running in parallel with the application server(s) 204 and the database 210 can be provided for added system and data security.

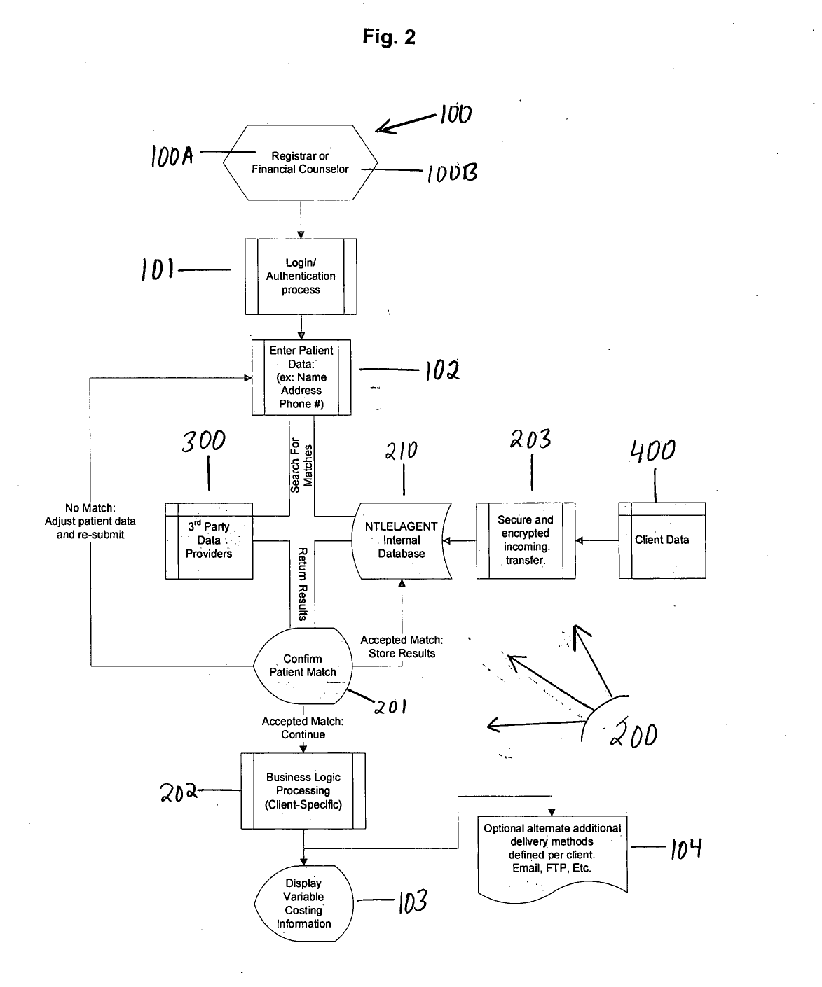

Referring to the flow diagram in FIG. 2, a registrar 100A or financial counselor 100B, who are healthcare service provider 100 employees, can access the self-pay management system 200 after clearing a login and authentication portal 101. (As used herein, the term ‘client’ is used interchangeably with the term ‘service provider’). The employee can then enter patient or guarantor identification data at terminal 102, including name, address and telephone number. This information can initially be sent to the self-pay management system 200 to verify the identification data. Third party data providers 300 can be queried, and the data returned are compared by processor 201 with the data entered from terminal 102.

A positive match causes business logic processor 202 to acquire and process additional information obtained from the third party data providers 300. The information gathered is also stored in an internal database 210 in the self-pay management system 200. Processor 202 also receives and processes service provider data 400, entered and stored within the internal database 210, after first being encrypted and transmitted through a secure channel 203. In the case of a healthcare provider, this data includes known financial data concerning the patient or guarantor, rules on how to categorize the financial profile of the patient or guarantor, a listing of services and expected charges based on categories of service (e.g., patient diagnosis), and any other demographic data about the patient or guarantor that the provider may have already acquired. Patient, guarantor and provider data can be encrypted, for example, by using AES technology within a Microsoft SQL Server 2005 platform. The data is automatically decrypted when displayed. Summary data is generated by the processing unit 202 based on the additional data received from the third party data providers 300 in conjunction with the service provider data 400. It is displayed 103, providing a financial profile of the patient or guarantor, including an estimate of their ability to pay, and optionally one or more payment plans. If additional information (such as a balance due or an updated estimated cost of service) is required to complete this task—and is not already present within the internal database 210—the provider employee 100 can be queried by the processing unit 202 to supply this information. The summary data generated by the processing unit 202, can be transmitted by a number of means 104, depending on provider preference.

Table 1 shows how a representative embodiment of the internal system database 210 can be partitioned into various functional folders, depending on the service provider's needs and the data retrieved and stored by the self-pay management system.

TABLE 1

| Folder | |
|---|---|
| Designation | Data Content/Function |
| Payer Data | type of data retrieved from a data provider, time stamp, |
| | link to patient record |
| Payer Data | individual data elements pertaining to each patient or |
| Detail | guarantor |
| Payer | identification data: name, address and telephone number |
| Contact | |
| Payer | linking multiple possible Payer Contacts with one account |
| Provider | service provider to which Payer data must be linked |
| Provider | tracking the product(s) requested from each third party |
| Query Type | data provider, linked to Payer Data |
| Data | high level groupings of data available for retrieval by |
| | service providers |
| Data Value | parsing rules for data retrieved from data providers |
| Data | data value rule set for each data element, uniquely |
| Provider | preset for each data provider and product |
| Xref | |

If the patient or guarantor identification data entered at terminal 102 does not match the data obtained from third party providers 300, server 201 sends a message to that effect to terminal 102 for corrective action by the provider employee 100. This process can be repeated until the identification information provided by the employee 100 matches the identification information provided by the third party data providers 300.

One of the objects of the present invention is to furnish the service provider with independently sourced information to verify the identity and to develop a reliable financial profile of the patient or guarantor. This information can, for example, be obtained from third party providers 300 such as Accudata Technologies (billing name and address verification; bankcard validation services), Accudata America (household information, mortgage and auto loan amounts, length of residence, etc.), or Acxiom (identity and asset verification; providing market segmentation data based on income, age, etc.). It will be apparent to those of ordinary skill in the art that other information of a similar nature can be obtained from other third party sources, and used to generate a similar financial profile of the patient or guarantor.

A payment plan can be generated, for example, by referring to a table previously prepared in conjunction with a service provider. The table can be used to map financial profile or ability-to-pay variables to payment plan variables. For example, for any given variable in the financial profile data set, a range of values can be mapped to a specified value of a variable in a payment plan data set. Examples of payment plan variables can include (but are not limited to) total discount, percentage and amount of payment made up-front, duration of payment term, number of payments, interest rate, and risk premium adjustment based on whether automatic payment debits can be arranged. The resulting values for each payment plan variable can then be summarized and sent to the service provider. Several payment plan options can be constructed for each account, for example, by having the system first calculate the net present value of an initial plan. A particular variable of the payment plan can then be changed, for example, by adjusting the remaining variables to keep the net present value of the plan constant.

One method of quantifying a guarantor's ability to pay includes developing an Opportunity Matrix, as shown in Table 2. After acquiring the patient or guarantor's financial and social profile from the service provider and third party sources, the self-pay management system can assign the individual to one of 16 categories based on four specified levels of income and four specified levels of net worth. The Opportunity Matrix thus generated can help to place the guarantor on a probability continuum of ability to pay; higher net worth and higher income yields the highest probability of collection, and low net worth and low income yields the lowest probability of collection. Experience suggests that absence of data on income/net worth places the individual in a risk category between low income/net worth and moderate income/net worth. The self-pay management system can apply this categorization to select a course of action most likely to maximize the service provider's reimbursements.

TABLE 2

| | | | |
|---|---|---|---|
| High Income | High Income | High Income | High Income |
| Low Net Worth | No Net Worth | Moderate Net | High Net Worth |
| | Data | Worth | |
| Moderate Income | Moderate | Moderate | Moderate Income |
| Low Net Worth | Income | Income | High Net Worth |
| | No Net Worth | Moderate Net | |
| | Data | Worth | |
| No Income Data | No Income | No Income | No Income Data |
| Low Net Worth | Data | Data | High Net Worth |
| | No Net Worth | Moderate Net | |
| | Data | Worth | |
| Low Income | Low Income | Low Income | Low Income |
| Low Net Worth | No Net Worth | Moderate Net | High Net Worth |
| | Data | Worth | |

As a further example, the health care provider's payment policies toward its customers can be stratified according to three personal income ranges PI₁, PI₂, PI₃. If the customer agrees to make a minimum up-front payment at the time of registration, then an offer of discount D₁, D₂ or D₃ can be made, the values of which are determined by PI. This discount value is adjusted up or down based on the system's estimate of the customer's net assets A, household income HI and number of dependents D. The minimum up-front payment M, is a percentage of the total cost of services, which can be adjusted up or down based on the customer's estimated net household income NHI (household revenues minus household expenses), and subject to a cap based on HI.

The remaining payment schedule can then be comprised of monthly installments according to HI, estimated net cash flow and net assets A. The duration of the term can 1, 2 or 5 years depending on the range within which the customer's estimated net assets A are located. A further discount on the residual balance (eg: 5-7%) can be allowed if the customer agrees to automatic monthly debits from a credit card or debit card account. In the event of significant conflicts between the information derived from the expanded information profile from third party sources and the information the customer self-reports, the system can trigger a referral request to a financial counselor within the health care or other service provider's organization for further negotiations.

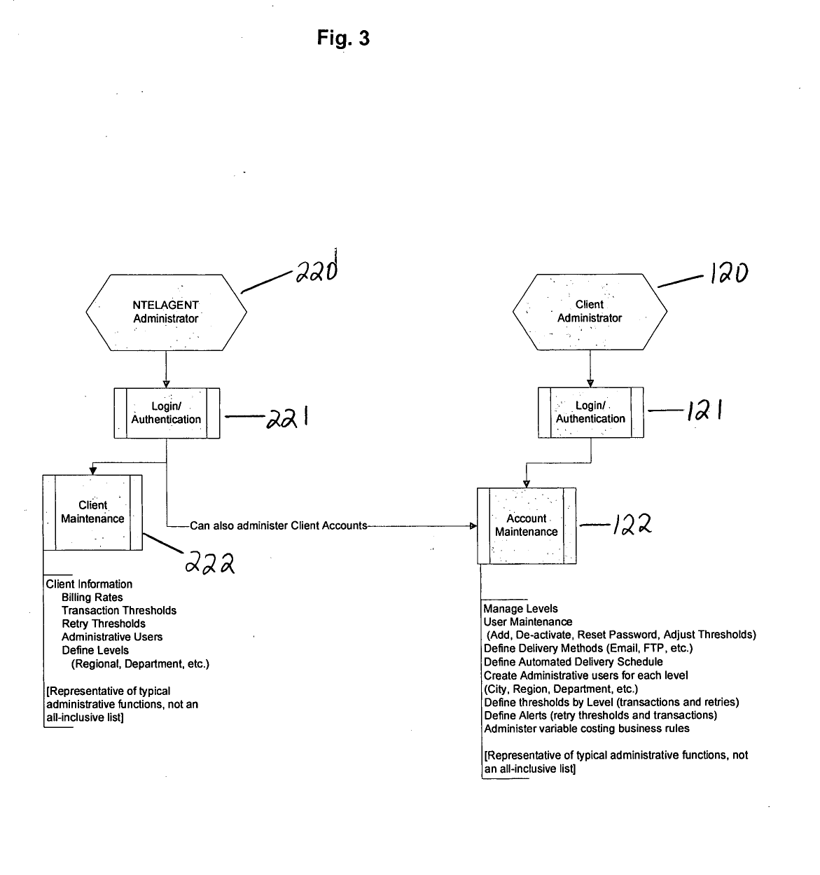

Referring to FIG. 3, the self-pay management system 200 can be administered both on the service provider side with a service provider administrator 120, and on the self-pay management system side with a system administrator 220. Either way, an administrator must clear a login/authentication portal 121 and 221, which can distinguish levels of access allowed for each administrator based on their roles in their respective organizations.

A service provider (or client) maintenance database 222 is maintained by the self-pay management system and includes service provider information pertaining to billing rates, transaction thresholds, client querying thresholds, access levels for administrative users at the service provider level, business rule payment terms, scripted phraseology (‘scripts’) for use by service provider registrars, financial counselors or others interfacing with the patient or guarantor, and reporting parameters and formats. The self-pay management system's service provider maintenance database 222 can also store separate sets of rules for individual service provider departments, offices or regions, depending on the size of the service provider. Other data and rules can be stored, as required by the individual circumstances of each service provider.

An account user maintenance database 122, maintained by the service provider, can include rules for levels of employee access to the system, depending on job description and managerial responsibilities. Individual user authorizations, passwords, access thresholds can also be updated and stored. Modes of communication with the system (email, FTP, etc.) can be defined and stored. Access for editing or applying payment plan rules also can be defined and stored in this database. User lists can be maintained for managing alerts and information requests from the self-pay management system, and for delivering financial reports or updates. The administrator of the self-pay management system can access some or all of this information, and implement service provider-specific parameters, set transaction thresholds and billing rates, and perform other functions in a relatively seamless manner with the service provider.

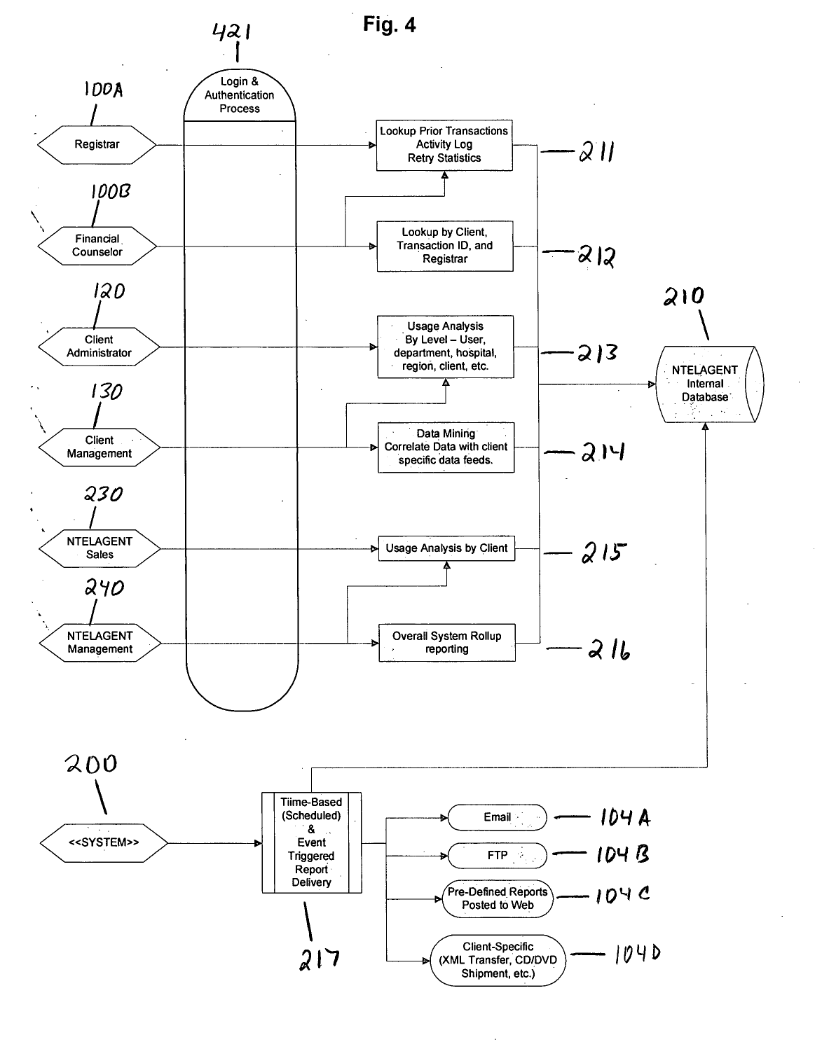

Referring to FIG. 4, a representative hierarchy of access to various components of the self-pay management system is shown. In all cases, a login and authentication portal, collectively denoted by 421, must be cleared by each user. A service provider registrar 100A or financial counselor 100B may have access to prior patient/guarantor transactions, an activity log, and retry statistics (repeat requests by the self-pay management system for additional or more accurate data) (211). A financial counselor 100B may additionally have access to information regarding a larger group of patients or accounts, in addition to the names of the registrars 100A who were involved with each account (212). A service provider administrator 120 can obtain statistics on user access to the system by department, office or region, in addition to administering user authorizations and access thresholds for the service provider's employees as outlined above (213). Service provider senior management 130 can review the financial performance of the accounts, either individually or collectively through various reports (214) generated by the self-pay management system 200. Sales or account associates for the self-pay management system 230 are able to obtain reports detailing usage activity for each of their service provider accounts (215). Managers of the self-pay management system 240 can monitor and obtain reports on the operation of the overall system (216), and can set up filters for highly restricted or sensitive data. For example, access to data elements such as a guarantor's net amount due, or estimated household income can be restricted. In such cases, the system 200 can be programmed to replace the raw data with Low, Moderate and High level phraseology for lower-level users, depending on the values of the restricted data elements.

For auditing purposes, the system internal database 210 can also track every action taken to access information on the system, including user look-ups, user updates, creation of new access levels, assignment or reassignment of personnel to an access level, the identity of persons resetting passwords and the details associated with setting up new users, new user roles, or details regarding the modification of any service provider or guarantor data or rules.

The system processor 202 also can be programmed to generate reports 217 for use by the service provider administrators 120, the service provider senior managers 130, the self-pay management system sales personnel 230, and the self-pay management system managers 240. The reports 217 can be generated on time-based or event-based schedules. Depending on the nature and urgency of the report, delivery can be effected by email 104A, FTP (File Transfer Protocol) or XMLTP (Extensible Markup Language Transfer Protocol) 104B, web-posting 104C, or traditional postal services 104D.

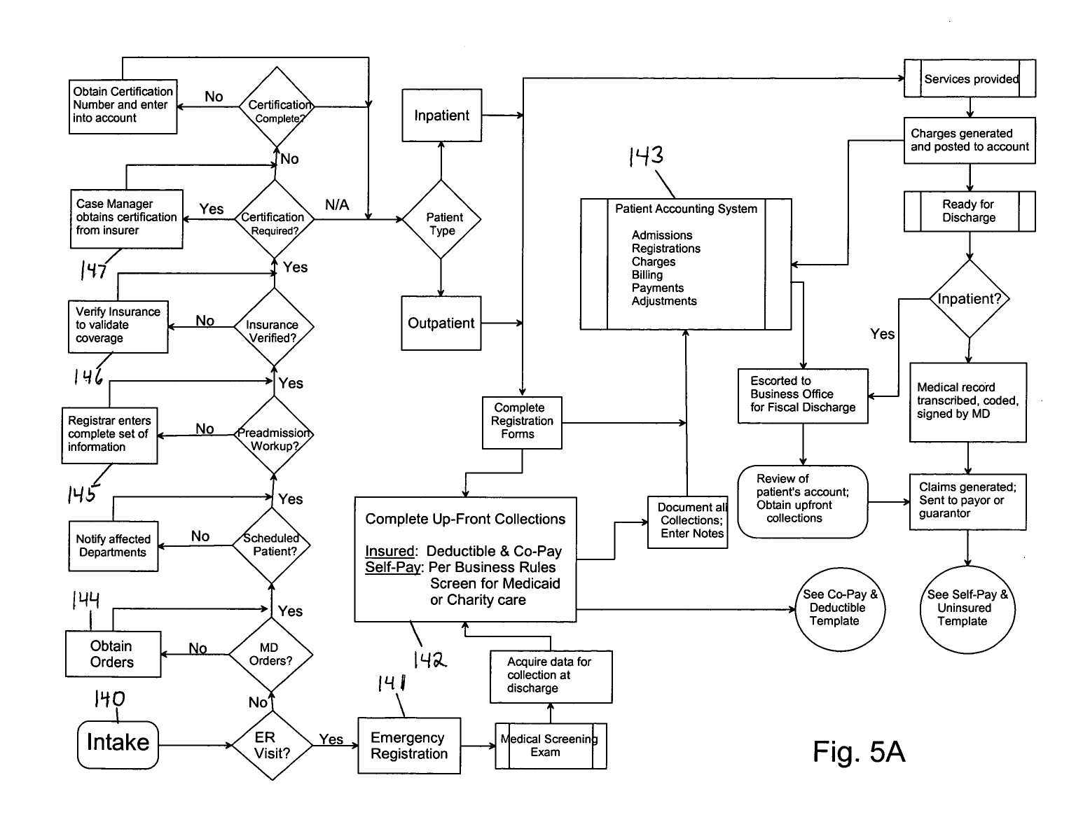

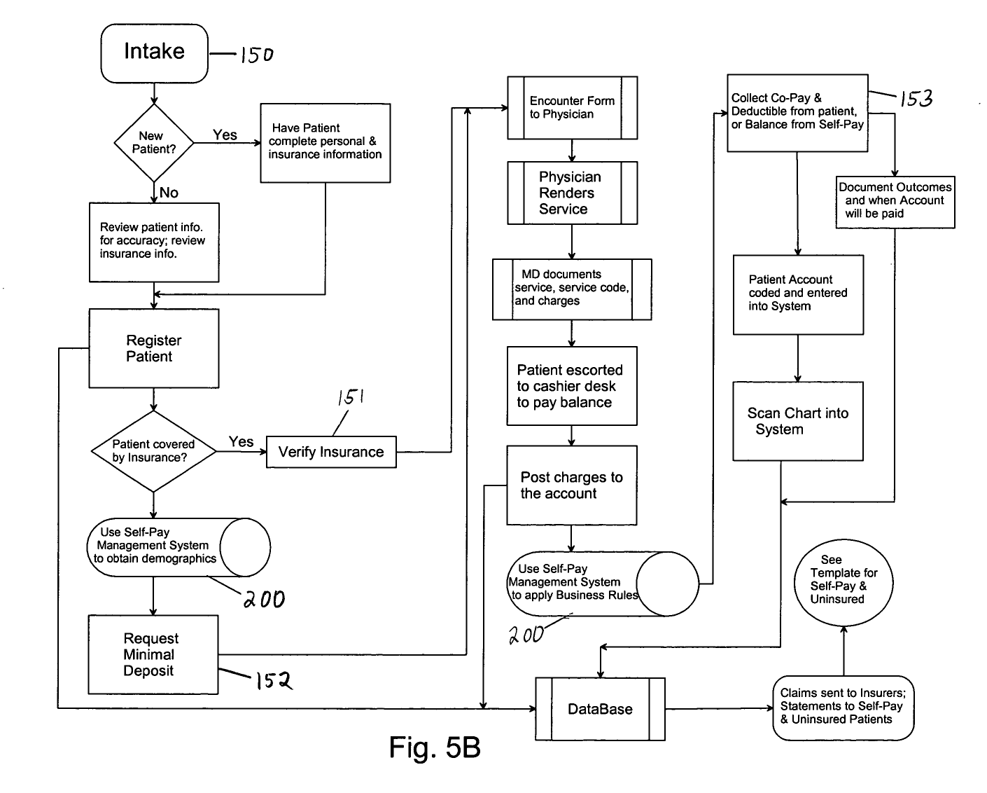

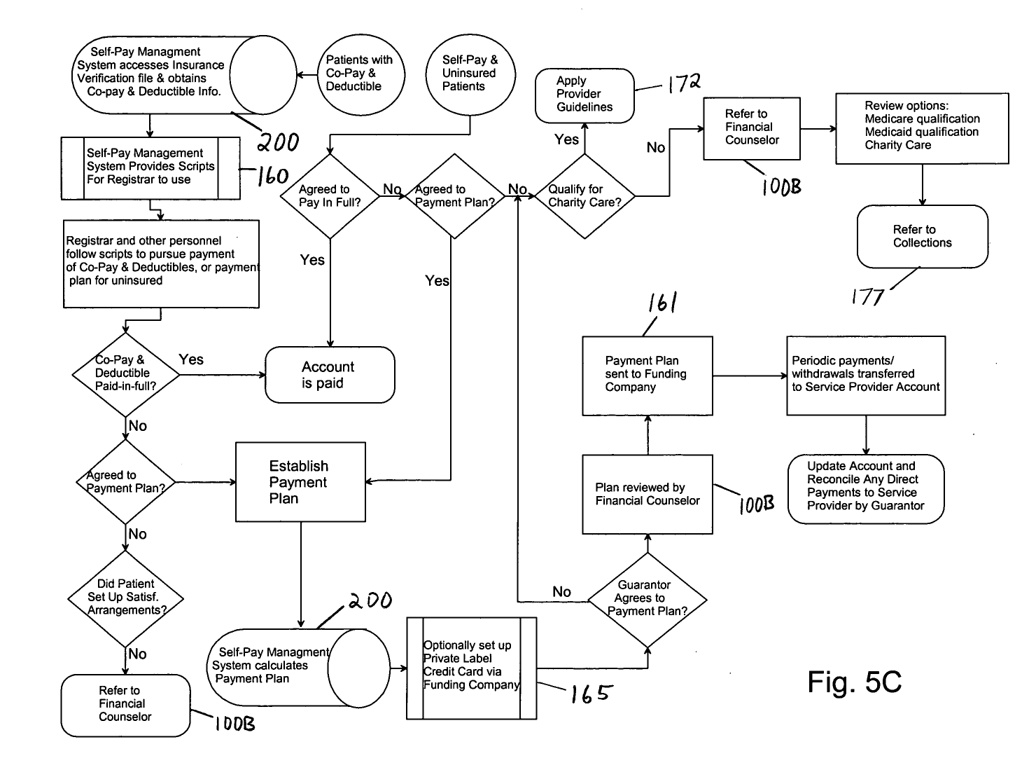

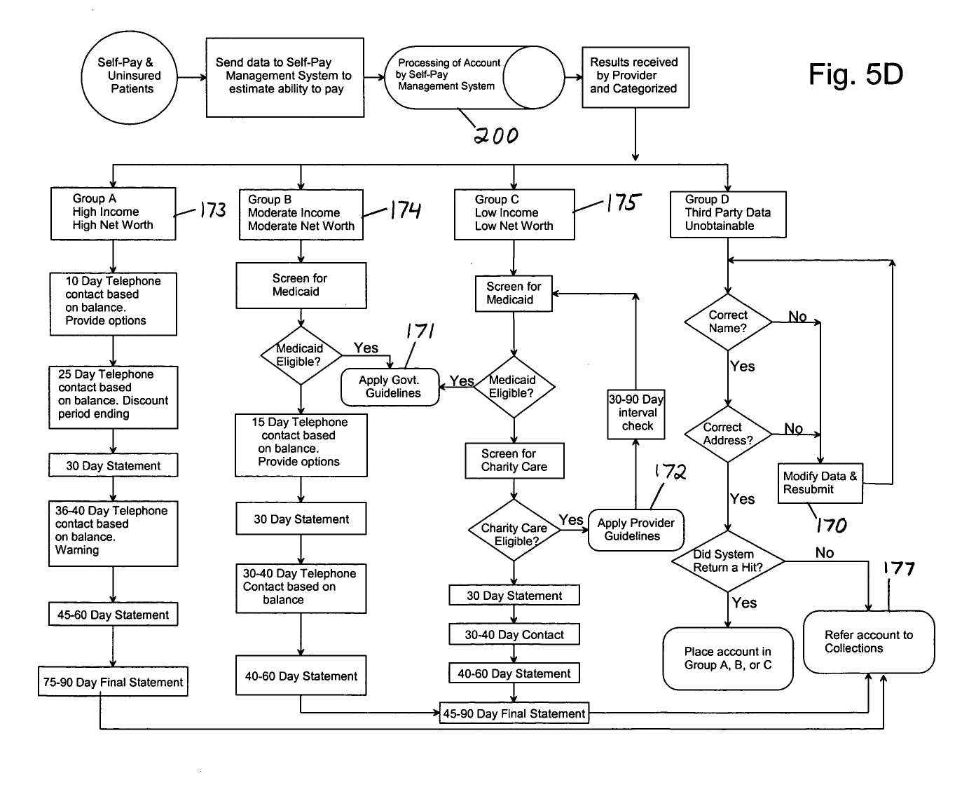

The flow diagrams of FIG. 5A-5D show areas in a service provider's accounting and revenue processes in which the self-pay management system can be used. Referring to FIG. 5A, at registration 140, the registrar can submit the identification information of the patient or guarantor. This information can be transmitted to the self-pay management system, which can—in real time—provide the registrar with guidance about whether to offer a payment plan tailored to the patient's or guarantor's financial profile, or to refer the patient or guarantor to a Medicaid qualification counselor, or outside vendor. In cases of registration for emergency services 141, a medical screening exam and initial treatment will often precede a complete acquisition of information, and will generally precede payment collection procedures. If the self-pay management system has been tasked with coordinating insurance verification, then any information on co-pays or deductible amounts owed at the time of service can be obtained during treatment in the emergency department, and up-front collections can be sought prior to discharge 142. A payment plan more likely to be accepted by the patient or guarantor can be offered on the day of service. Alternatively, the registrar can help to pre-qualify the patient or guarantor for a government or community assistance program, such as Medicaid. Non-emergency services can go through a pre-qualification procedure. Scheduled patients can be speedily processed if written order have been delivered ahead of time 144. Other procedures by the registrar include checking for pre-admission testing 145, Insurance coverage can also be verified, and co-payments and deductibles can be determined 146. In some cases, pre-certification by the insurance company must be obtained 147 before the registration process can be completed.

Another point of access to the self-pay management system can occur when a registrar or financial counselor 142 interacts with the patient or guarantor, as shown in FIG. 5A. The counselor can also access the financial profile of the patient/guarantor in order to present and arrange reasonable payment options, or to identify optimal programs to assist the patient/guarantor in meeting their obligations (either through government, community or other assistance programs). Optionally, the self-pay management system can supply the service provider with financial counseling support through a Virtual Counseling Service. Ideally, this can be available to any personnel with appropriate authorization on a 24-hour basis. The service can supply the provider's employee with scripted phraseology to explain the provider's financial policy and to inform patients or guarantors of their financial responsibilities. It can also include the ability to review the payment options available to an individual patient/guarantor, to modify payment options (within certain pre-determined constraints), to recommend a workable payment program for the patient/guarantor, to initiate Medicaid qualification procedures, and to identify and recommend community and government assistance programs that could assist the patient/guarantor. A further point of contact with the self-pay management system can occur through the central patient accounting system 143, in which data on charges, payments and adjustments is centralized and accumulated.

Referring to FIG. 5B, a more simplified process of registration and account tracking is available in, for example, an office setting, a clinic, or an outpatient surgery or diagnostic center. At registration 150, the registrar can submit the identification information of the patient or guarantor. This information can be transmitted to the self-pay management system 200 via an interface engine in real time. For accounts with insurance, the self-pay management system can coordinate with the insurance verification process 151 and systematically extract the data necessary to populate the co-insurance and deductible fields of the self-pay management system visit form. Those accounts without insurance coverage can continue through the system as self-pay accounts and can be subject to the healthcare provider's business rules (which have been previously entered into the system). The account, processed in real time, is presented to the registrar with scripted phraseology previously prepared by the healthcare provider targeting the financial profile of the patient. This helps the registrar to request an appropriate up-front deposit on the services requested 152. These scripts (160 in FIG. 5C) are embedded into the self-pay management system and can refer the patient or guarantor to a Medicaid qualification counselor, or outside vendor. A payment plan more likely to be accepted by the patient or guarantor can be offered at the initiation 152 or completion 153 of service. Alternatively, the registrar can help to pre-qualify the patient or guarantor for a government or community assistance program, such as Medicaid.

Referring to FIG. 5C, another point of access to the self-pay management system can occur when a financial counselor 100B interacts with the patient or guarantor. The system allows the service provider to enter scripted phraseology (‘scripts’) 160 that the registrar or other employee can use when communicating with the patient or guarantor about payment for services. The counselor can also access the financial profile of the patient/guarantor in order to present and arrange a reasonable payment plan 161 recommended by the self-pay management system 200, or to identify optimal programs to assist the patient/guarantor in meeting their obligations (either through government, community or other assistance programs). Optionally, the self-pay management system can supply the service provider with financial counseling support through a Virtual Counseling Service. Ideally, this can be available to any personnel with appropriate authorization on a 24-hour basis. The service can supply the provider's employee with scripted phraseology to explain the provider's financial policy and to inform patients or guarantors of their financial responsibilities. It can also include the ability to review the payment options available to an individual patient/guarantor, to modify payment options (within certain pre-determined constraints); to recommend a workable payment program for the patient/guarantor, to initiate Medicaid qualification procedures, and to identify and recommend community and government assistance programs that could assist the patient/guarantor. If the patient/guarantor requests longer term payments, a healthcare service provider will be less reluctant to acquiesce, because the self-pay management system can prepare payment terms automatically for an indefinite period or as long as the service provider will permit. Optionally, the service provider can avail itself of a private label credit card facility coordinated by the self-pay management system to act as a fiscal intermediary for periodic payments 165. For ease of payment, arrangements can be made for a credit card processing company to process private label credit cards along with more traditional cards such as MasterCard Visa, etc.

FIG. 5D shows how payment processing can be tailored to the guarantor's estimated ability to pay, and how an accounts receivable system can be designed based on the Opportunity Matrix shown in Table 2. This system can be structured to operate as a batch process when registration is complete and services have been rendered. It can also apply to billing services for hospital-based practitioners, such as radiologists, emergency physicians, and anesthesiologists, who rely on the employees of other healthcare providers to perform the registration tasks. FIG. 5D also shows the system attempts to verify the identification, demographic and market information of a patient or guarantor, by requesting modification and resubmission of data 170 before proceeding.

For example, government-sponsored accounts 171, and accounts designated to charity care 172, can be generated from various categories of guarantors (e.g., Group B 174 and Group C 175), by virtue of the service provider's access to updated information from the self-pay management system 200. Personnel responsible for Medicaid accounts 171 can direct patients to a financial counselor 100B (FIG. 5C) for other payment options or for consideration of charity care 172. Accounts assigned to charity care 172 can be periodically reviewed 176 to ensure the continued appropriateness of this designation. Accounts assigned to charity care 172 can additionally be monitored for appropriate follow-up if government programs, non-profit organizations or foundations have qualified the patient/guarantor for financial support.

The aging of accounts can be grouped according to the financial profiles of the patients/guarantors in order to optimize the point at which accounts will be referred to external collection agencies 177. As shown in FIG. 5D, programs for sending out billing statements and making telephone contacts can be varied according to the group to which a given patient or guarantor has been assigned. In addition, statement mailings can be triggered at various times after the service has been rendered, depending on whether the service provider is an inpatient facility, outpatient component of a hospital, clinic, outpatient surgical or diagnostic center, or physician's office. An earlier contact or statement date can also be programmed, for example, depending on the amount the guarantor owes on his or her balance. With each contact, the self-pay management system can guide the individual employee through a list of individualized options, depending on such factors as the amount owed, whether a substantial up-front payment was made, whether a discount was offered, and whether the patient or guarantor was willing to arrange for automatic credit card or checking account debits.

The following examples are provided to show how the user interface between the service provider employees and the self-pay management system can be designed. The interface specifies which aspects of the program can be accessed, and at what level. Such limitations are well known to those skilled in the art; the examples provided are therefore not meant to be limiting features of the invention herein disclosed.

### EXAMPLE 1

### User Interface

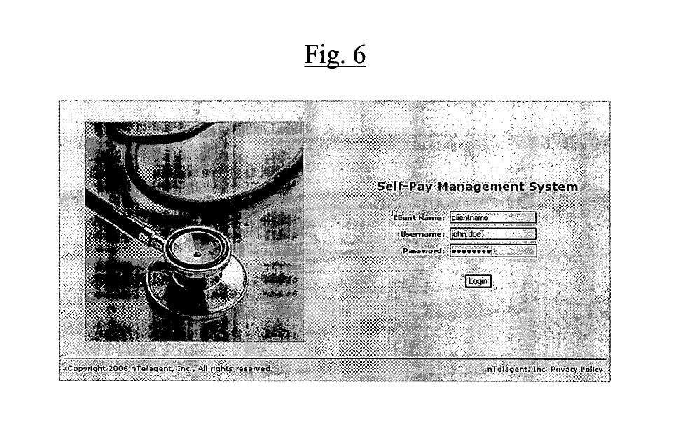

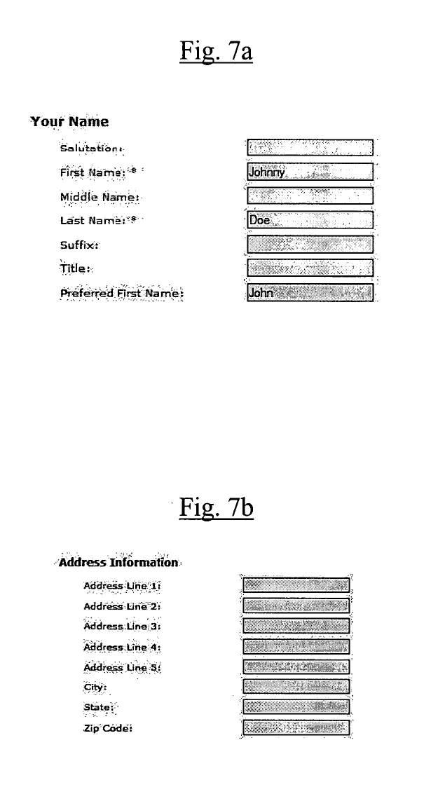

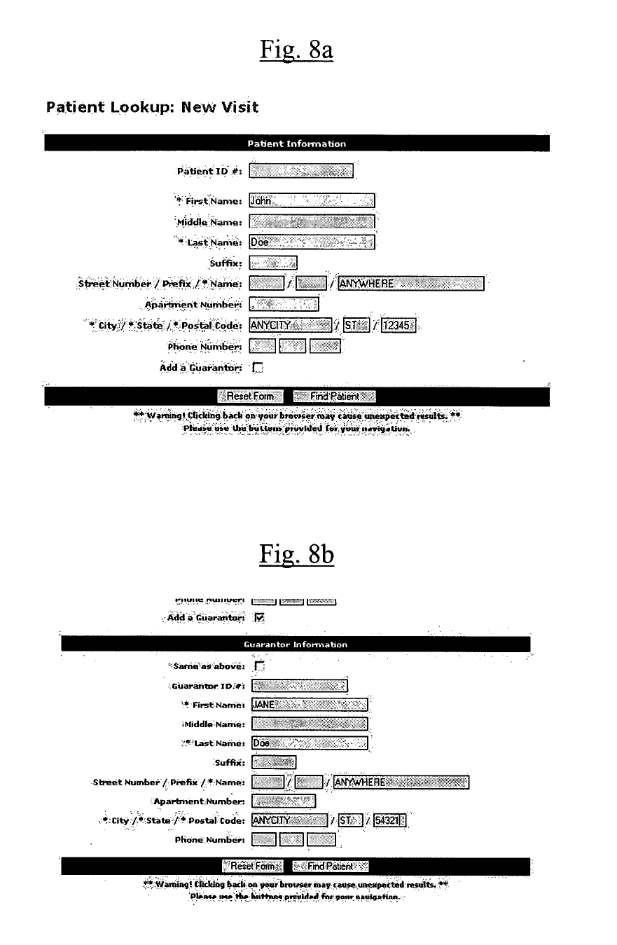

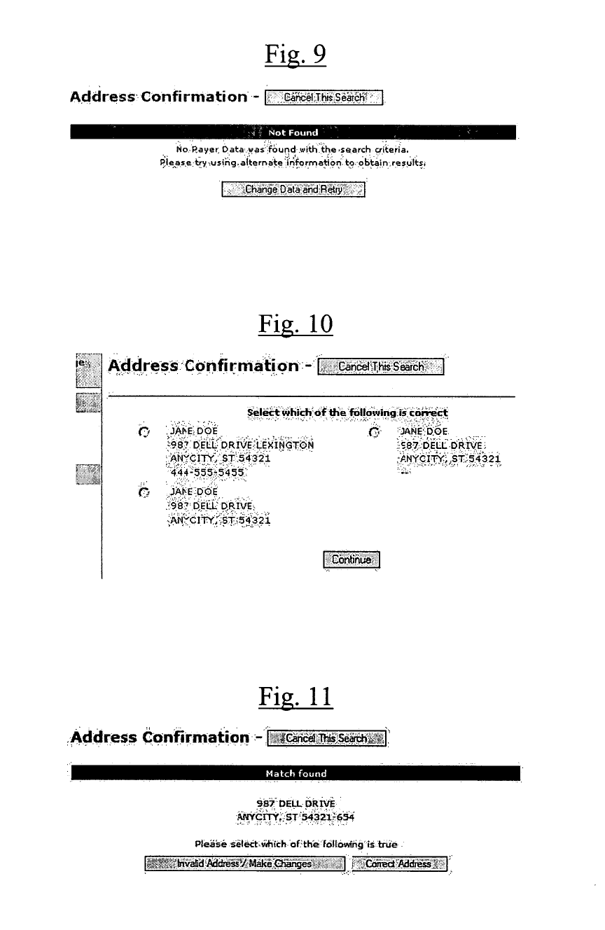

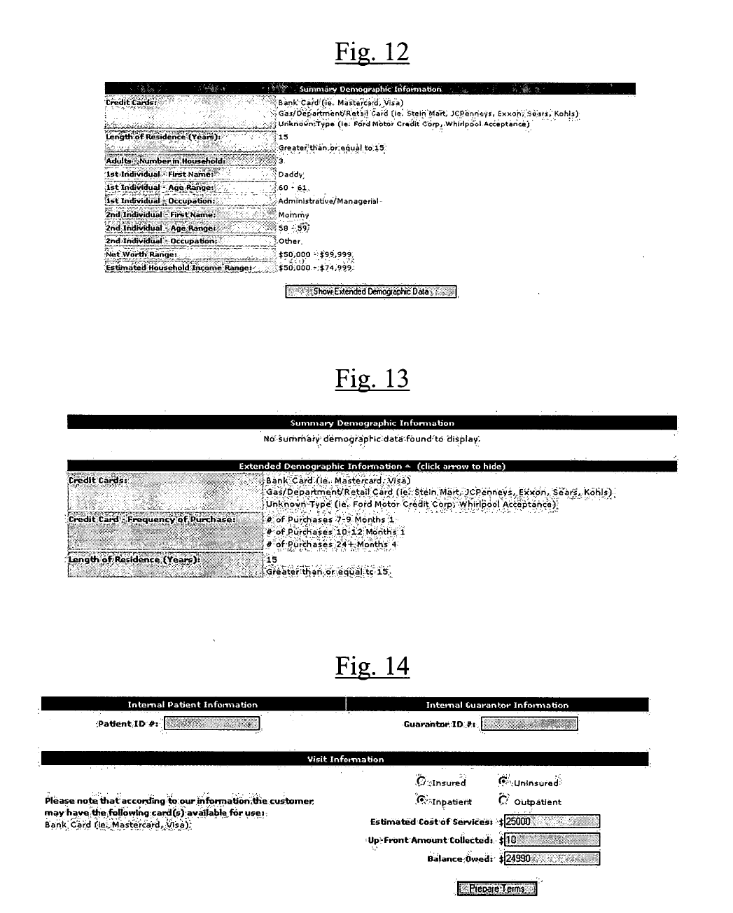

FIG. 6 shows a representative login page through which a user authorized by the service provider can gain access to the self-pay management system. Communications occur with the self-pay management system through a server appropriately programmed to respond to input from the user's computer terminal. In order to protect confidentiality of the information, the system (via the login page) is accessed through a secure web server, using for example, Secure Sockets Layer, which encrypts the data being transmitted. The Login Screen requires the user to enter a client name, user name and password. Each user is provided a user account by a service provider-designated Administrator 120. After clearing the login portal to access the system, a user can enter his or her contact information, including name, title, and location, as shown in FIG. 7a and FIG. 7b. As shown in FIG. 8a and FIG. 8b, a user such as a registrar or financial counselor can enter patient and guarantor data, such as name, address and telephone number. This information is transmitted to the server of the self-pay management system (or “decision support provider”), where the information is compared to data obtained from the system's internal database 210 or from third party data providers 300. If the accuracy of the identification information cannot be verified, the healthcare provider receives a message to that effect and is asked to re-submit corrected information, as shown in FIG. 9. If the system server returns more than one possible address match, the user is asked to select the correct one, as shown in FIG. 10. Once the initial consumer data is verified, the user is so informed, as shown in FIG. 11, at which point the user can accept the information. User selection of the correct patient or guarantor triggers the server to initiate access to third party data sources 300, and obtain additional patient or guarantor-specific demographic and lifestyle data (also herein referred to as an expanded financial profile). The information is organized and stored in the self-pay management system's internal database 210. It is added to previously stored historical information derived from the healthcare service provider. Depending on the level of authorization of the user (such as financial counselor vs. registrar), some or all of the demographic and consumer spending information shown in FIG. 12 and FIG. 13 can be displayed on the user's screen. The data available at any given authorization level is preset by the service provider administrator 120.

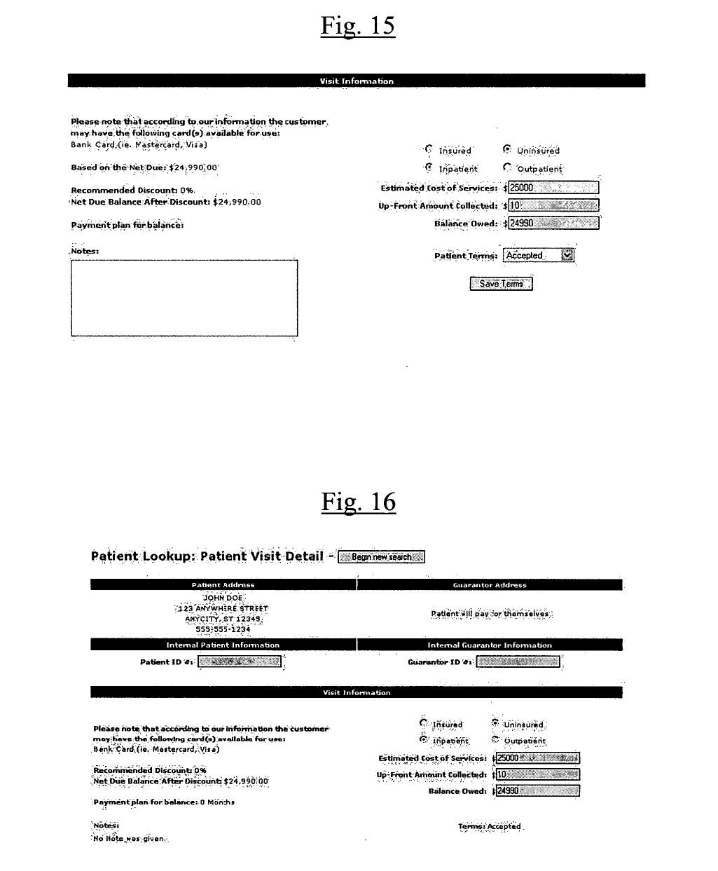

Data and processing rules specific to the healthcare provider are also preset in the system's internal database 210, and this information can be updated by an authorized service provider administrator 120 or more senior manager 130, depending on the service provider's policies, procedures and experience within its specific market. To maintain confidentiality of the information, transmission and entry of this data is also subject to authentication and encryption. The self-pay management system can then apply the healthcare service provider's rules to process the patient's or guarantor's expanded financial profile through its business logic processing unit 202. The resulting summary information and recommended course of action then can be transmitted to the healthcare provider, where predicted costs can be displayed, depending on the payment and collections procedures chosen. For example, FIG. 14 shows a user's computer terminal display of the estimated cost of service, amount collected and balance owed. Additionally, as shown in FIG. 15, the terminal can display information derived from the guarantor's financial profile, including credit card data and a recommended discount. The user can designate the “Terms” field as “Accepted” if the proposed terms are accepted by the guarantor or patient, as shown in FIG. 16.

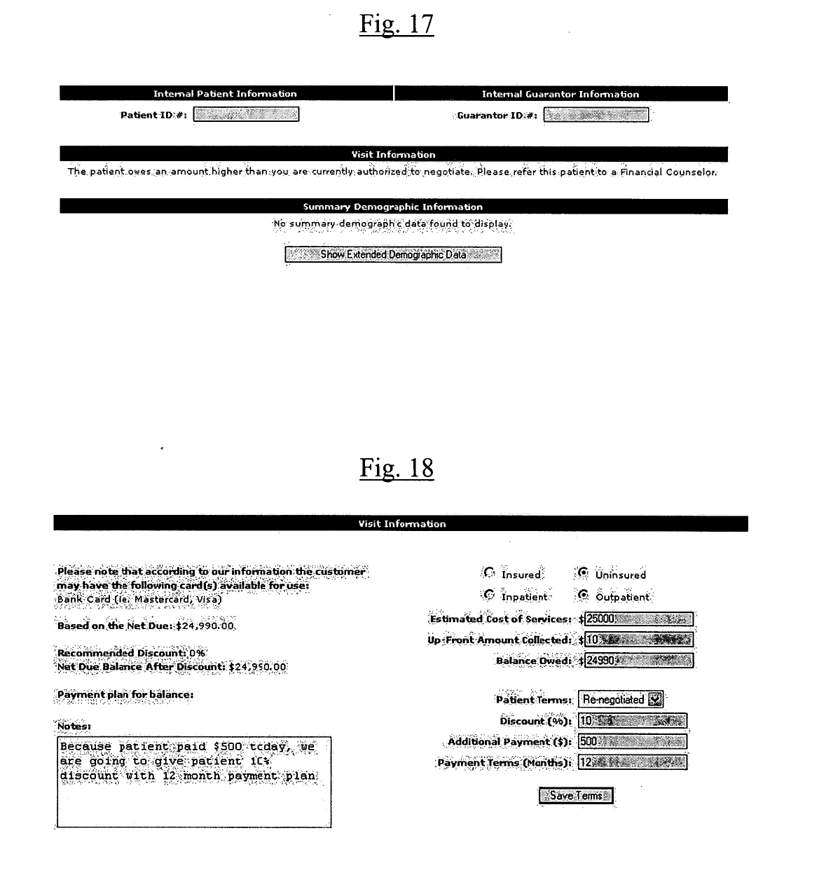

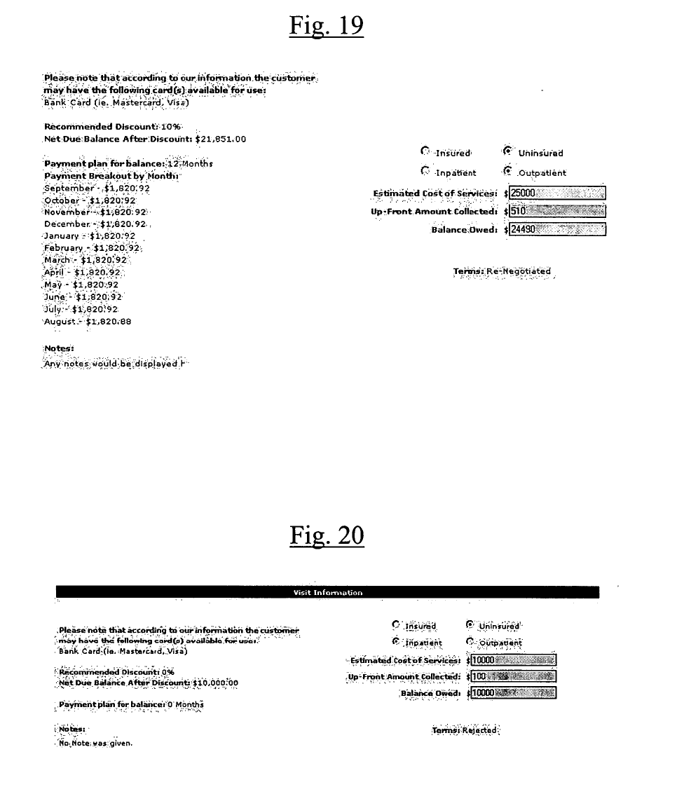

Should the estimated cost of service exceed the amount that a particular user is authorized to process, the server can inform the user of the need to refer the matter to an individual at a higher level of authority (such as a financial counselor, for example), as shown in FIG. 17. Assuming that the user has the appropriate authorization, new terms can be re-negotiated (within specified parameters). In that case the user can enter a new payment plan, as shown in FIG. 18. In this particular illustration, for example, the patient paid $500, allowing the user to offer the patient a 10% discount with a 12-month payment plan. Acceptance of the plan triggers the server to calculate and display a detailed payment plan, as shown in FIG. 19.

Should the patient or guarantor reject the offer, it can be noted in the system, as shown in FIG. 20, whereupon a rejection notice can be generated by the server and delivered to the patient or guarantor, using scripted phraseology detailing the service provider's policy on the matter. The content of the notice optionally can be made to vary depending on the patient's or guarantor's financial profile, the user level (e.g. registrar vs. financial counselor), and the particular region or department involved.

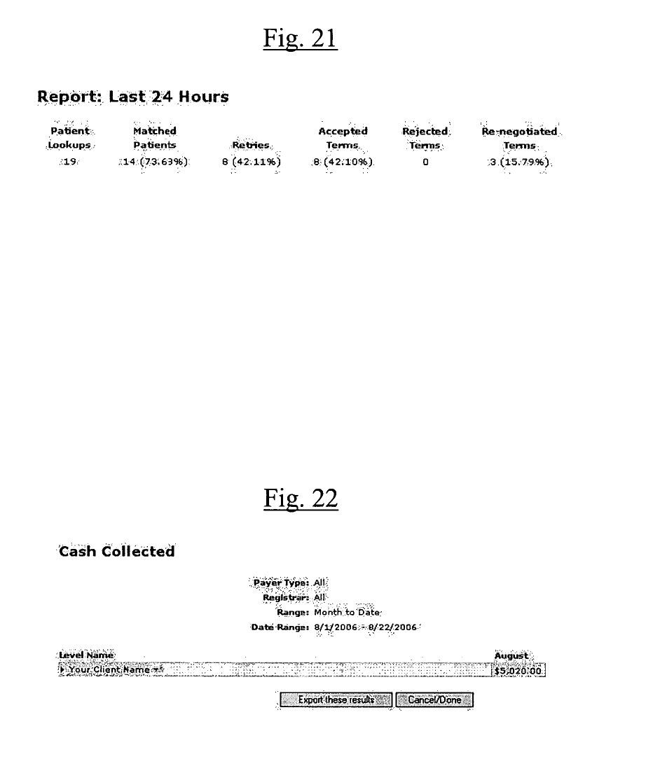

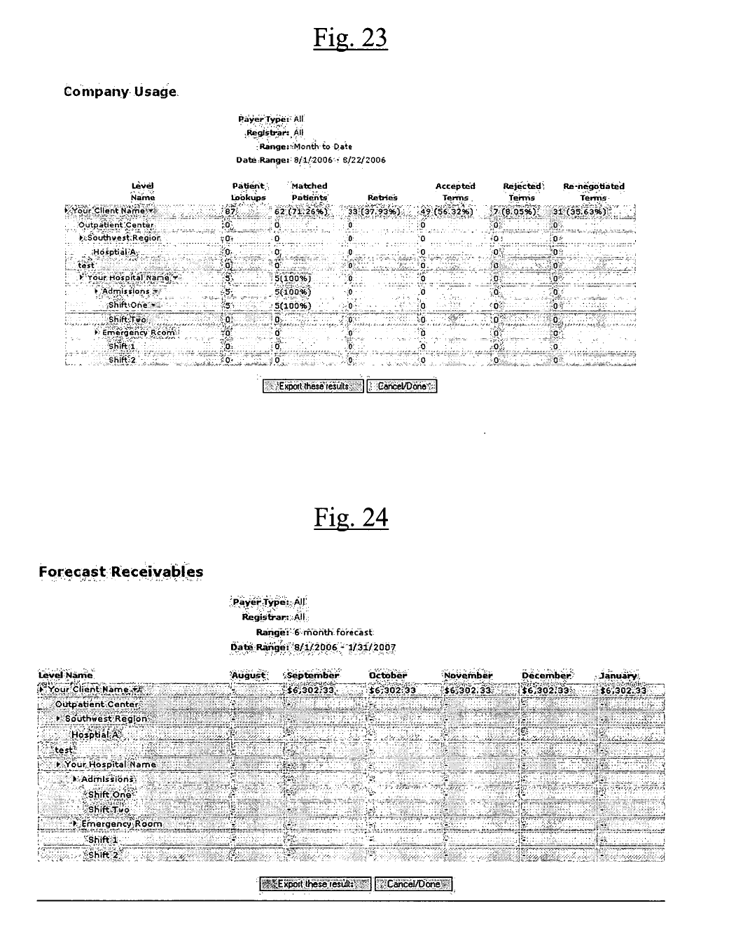

The self-pay management system can be programmed to generate and deliver reports of patient encounters based on activity within the preceding 24 hours, as shown in FIG. 21. Similar reports can be generated for any given week or month. Cash collections can be reported based on patient/guarantor profile, user, or specified reporting period, as shown in FIG. 22. Enterprise-wide statistics can be reported according to location or department, as in FIG. 23, and receivables forecasts can be generated, and differentiated according to location, department, work shift, or other suitable parameters, as shown in FIG. 24. Any or all of this information can be transmitted in a service provider-selectable format via email, web page, regular mail or other means as pre-arranged by the service provider.

### EXAMPLE 2

### Administrator Interface

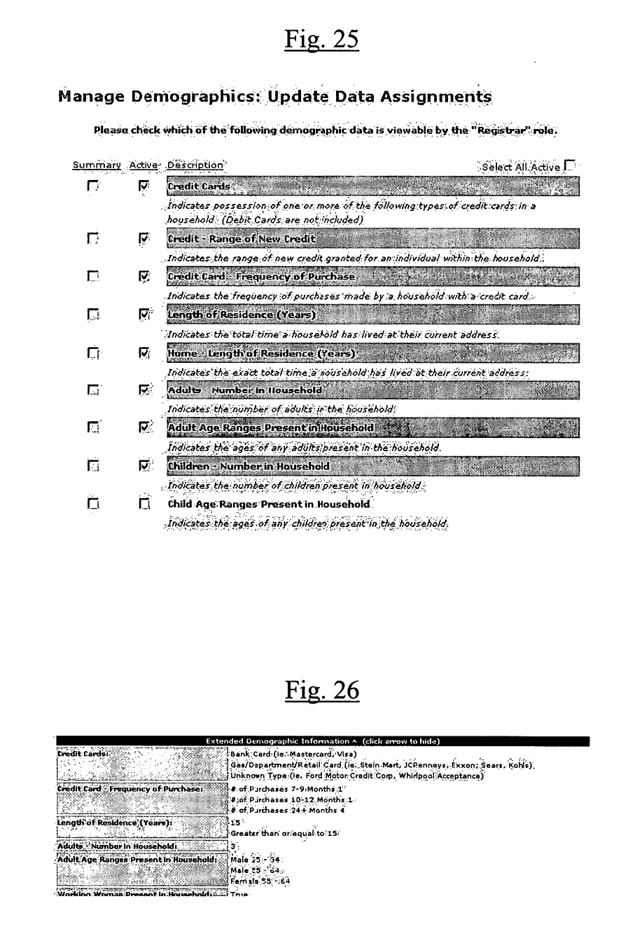

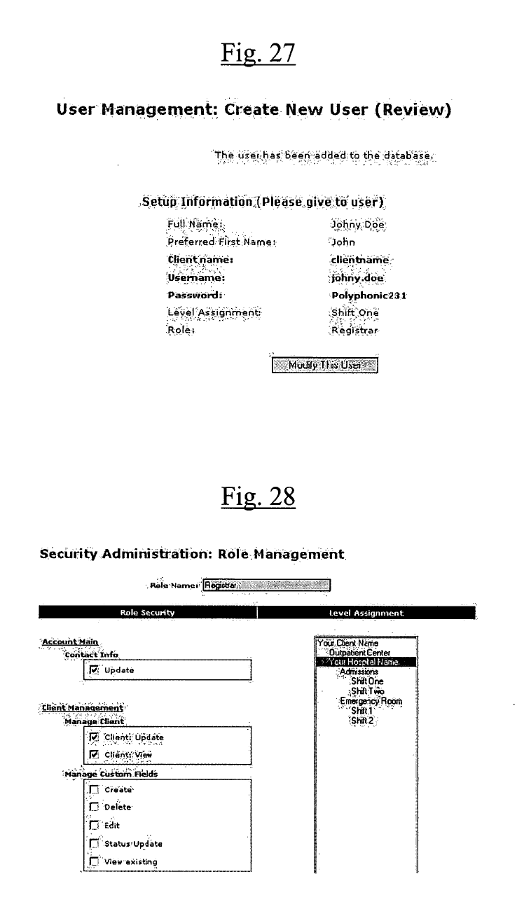

The service provider administrator 120 can have the ability to select the categories of demographic or market information pertaining to patients/guarantors to which a user category will have access, as shown in FIG. 25. The data can be categorized as either ‘summary’ data or ‘active’ data. Referring to FIG. 26, the administrator can also select the types of extended demographic data to which a user will have access. Individual users can be assigned to a specific user level or Role, as in FIG. 27. For example, as shown in FIG. 28, the administrator 120 or senior manager 130 can separately assign access to update patient or guarantor contact information, to update service provider-specific data or parameters, or to view provider-specific data, parameters or rules. Customized access to various parts of the database 122 is also possible.

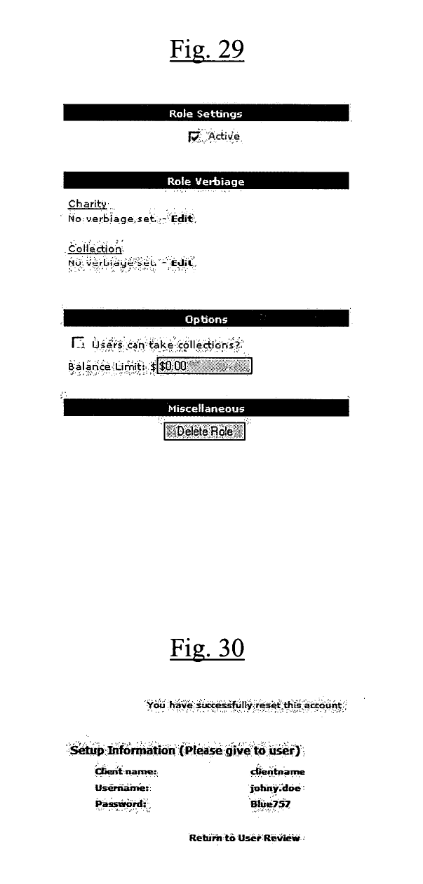

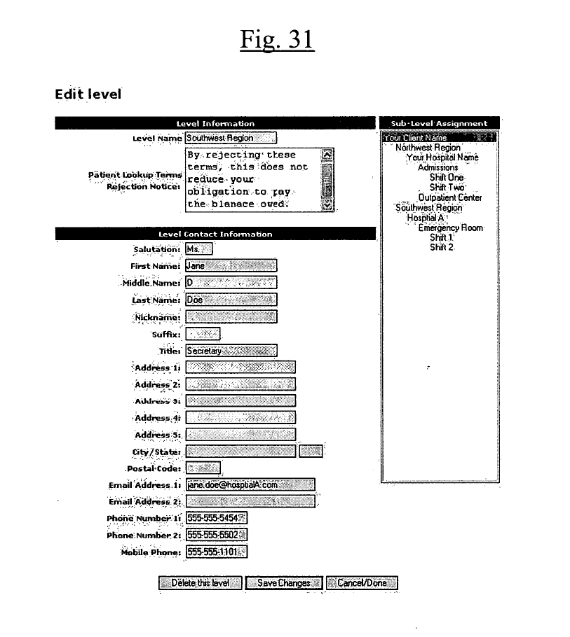

The administrator 120 or senior manager 130 can edit the script that communicates the service provider's various policies, for example, on payment for services, charity care or collections, as shown in FIG. 29. FIG. 29 also shows that the user optionally can be permitted to accept payments, which can be limited to a specified amount. The administrator 120 can also reset a user's username and password, as shown in FIG. 30. In addition, individual service provider policy determines levels of user access to the system, and can be delineated according to individual roles, work shifts, departments, locations, and regions, according to the provider's needs and size, as shown in FIG. 31.

The preceding examples are meant to provide representative, but not limiting, embodiments of the present invention. It will be apparent to one of ordinary skill in the art that many alternatives, modifications and variations of the self-pay management system described herein are possible, in light of the disclosure herein. It is intended that the metes and bounds of the present invention be determined by the appended claims rather than by the language of the above specification, and that the aforementioned alternatives, modifications and variations are to be included within the spirit and scope of these claims.

1. A method for obtaining payment for a service comprising the steps of:
a) submitting identification information about a guarantor responsible for a payment;
b) receiving data based on the identification information submitted, said data including a verification of the identification information, a financial profile of the guarantor, or an estimate of the guarantor's ability to pay for the service, or a combination thereof; and
c) presenting to the guarantor a payment plan based upon the data received.

2. The method of claim 1 wherein the step of submitting identification information comprises submitting the guarantor's name, the guarantor's address, or the guarantor's telephone number, or a combination thereof.

3. The method of claim 1 wherein the step of receiving the guarantor's financial profile comprises receiving demographic and market information about the guarantor.

4. The method of claim 3 wherein the step of receiving demographic and market information comprises information about the guarantor's residence, and includes the residence location, the residence duration, the residence occupancy profile, or the residence economic profile, or a combination thereof.

5. The method of claim 3 wherein the step of receiving demographic and market information comprises spending information about the guarantor, said spending information including the identity of at least one of the guarantor's credit card providers, the frequency of purchases made by the guarantor, or the value of purchases made by the guarantor, or a combination thereof.

6. The method of claim 1 further comprising the step of calculating the estimate of the guarantor's ability to pay based upon the guarantor's financial profile.

7. The method of claim 1 further comprising the step of calculating the payment plan based upon the data received.

8. The method of claim 7 wherein the step of calculating the payment plan comprises accepting a discount for the cost of the service, or receiving sequentially two or more partial payments, or a combination thereof.

9. The method of claim 8 wherein the step of calculating the payment plan is based on information comprising the estimated cost of the service, the guarantor's financial profile, the estimate of the guarantor's ability to pay, the amount of payment made at time of service, the discount, the number of partial payments, the duration of partial payments, or the amount of each partial payment, or a combination thereof.

10. The method of claim 1 wherein said payment comprises an insurance co-payment, or a deductible payment, or a combination thereof.

11. The method of claim 9 wherein said calculating steps are performed using a computer.

12. The method of claim 1 wherein the sending and receiving steps are performed using an electronic terminal, and occur over a communications pathway comprising a modem, wireless transceiver, telephone cable, coaxial cable, or fiberoptic cable, or a combination thereof.

13. The method of claim 1 wherein said data is obtained from one or more third parties.

14. A method for providing information about a guarantor responsible for payment for a service, comprising the steps of:
a) receiving from a service provider identification information about a guarantor responsible for a payment;
b) submitting the identification information to one or more third parties in order to obtain third party data, said third party data including information to verify the identification information or information to generate a financial profile of the guarantor, or a combination thereof;
c) receiving the third party data from the one or more third parties;
d) generating a summary from the third party data regarding the guarantor, said summary including a verification of the identification information, or a financial profile of the guarantor, or a combination thereof; and
d) sending the summary to the service provider.

15. The method of claim 14 wherein the step of submitting information derived from the identification information comprises submitting the guarantor's name, the guarantor's address or the guarantor's telephone number, or a combination thereof.

16. The method of claim 14 wherein the step of receiving the third party data to generate the guarantor's financial profile comprises receiving demographic and market information about the guarantor.

17. The method of claim 16 wherein the step of receiving the demographic and market information comprises information about the guarantor's residence, and includes the residence location, the residence duration, the residence occupancy profile, or the residence economic profile, or a combination thereof.

18. The method of claim 16 wherein the step of receiving the demographic and market information comprises spending information about the guarantor, said spending information including the identity of at least one of the guarantor's credit card providers, the frequency of purchases made by the guarantor, or the value of purchases made by the guarantor, or a combination thereof.

19. The method of claim 14 further comprising the step of calculating an estimate of the guarantor's ability to pay based upon the guarantor's financial profile.

20. The method of claim 19 further comprising the step of calculating a payment plan to present to the guarantor based upon the estimate of the guarantor's ability to pay.

21. The method of claim 20 wherein the step of calculating the payment plan comprises accepting a discount for the cost of the service or receiving sequentially two or more partial payments, or a combination thereof.

22. The method of claim 21 wherein the step of calculating the payment plan is based on information comprising the estimated cost of the service, the guarantor's financial profile, the estimate of the guarantor's ability to pay, the amount of payment made at time of service, the discount, the number of partial payments, the duration of partial payments, or the amount of each partial payment, or a combination thereof.

23. The method of claim 14 wherein the sending and receiving steps are performed using an electronic terminal, and occur over a communications pathway comprising a modem, wireless transceiver, telephone cable, coaxial cable, or fiberoptic cable, or a combination thereof.

24. The method of claim 22 wherein said sending, receiving and calculating steps are performed using a computer.

25. A system for gathering and processing information about a guarantor responsible for payment for a service, comprising:
a) first means for receiving and storing identification information about the guarantor;
b) second means for querying one or more databases using the identification information in order to obtain data from a third party, said third party data including information to verify the identification information or information to develop a financial profile of the guarantor, or a combination thereof;
c) third means for receiving the third party data;
d) fourth means for generating a summary regarding the guarantor based on the third party data, said summary including the financial profile of the guarantor, an estimate of the guarantor's ability to pay for the service, or a payment plan to be presented to the guarantor, or a combination thereof; and
e) fifth means for communicating to a service provider a verification of the identification information or the summary regarding the guarantor, or a combination thereof.

26. The system of claim 25 wherein the first, second, third and fifth means comprise at least one modem.

27. The system of claim 26 wherein the first, second, third and fifth means further comprise a wireless transceiver, telephone cable, coaxial cable, or fiberoptic cable, or a combination thereof.

28. The system of claim 25 wherein the first means further comprises a computer memory.

29. The system of claim 25 wherein the fourth means comprises a processor.
